(19) United States
(12) Patent Application Publication
(10) Pub. No.: US 2022/0297277 A1
(43) Pub. Date: Sep. 22, 2022

(54) HAMMER-CAP FASTENER

(71) Applicant: ROMP FASTENERS LLC, Las Vegas, NV (US)

(72) Inventor: Hollis C. HENDERSON, JR., Lincolnton, NC (US)

(73) Assignee: ROMP FASTENERS LLC, Las Vegas, NV (US)

(21) Appl. No.: 17/208,549

(22) Filed: Mar. 22, 2021

(51) Int. Cl. B25D 1/02

(52) U.S. Cl. CPC B25D 1/02; B25D 2250/051; B25D 2250/065; B25D 2222/61

(57) ABSTRACT

A hammer-cap fastener may include a fastener head. The fastener head may include one or more beveled edges along a lateral surface of the fastener head. The hammer-cap fastener may include a threaded body having a first end coupled to the fastener head. The hammer-cap fastener may include a ring circumscribing the first end of the threaded body such that the ring is positioned flush against the fastener head. The ring may include a first surface positioned flush against the fastener head and a second surface through which the threaded body extends, the first surface of the ring having a larger area than the second surface of the ring. The first surface and the second surface of the ring may be connected by a sloped lateral surface. The hammer-cap fastener may couple a hammer cap to a hammer head.

The present disclosure generally relates to a hammer-cap fastener.

### BACKGROUND

A hammer may include a handle and a head attached to an end of the handle. A hammer head may include one or more hammer caps. For example, the hammer may include a first hammer cap at a first end of the head having a circular cross-section and a second hammer cap at a second end of the head having a rectangular cross-section. Hammer caps may include various geometries and/or be made of various materials depending on a situation in which the hammer may be used.

FIG. 1 illustrates a conventional bolt 100 that is used to secure hammer caps to hammer heads. The bolt 100 includes a saddle head 110, a threaded nut 120, a collar 130, and a threaded body 140. The saddle head 110 is embedded in the hammer cap (not shown). The threaded nut 120 is screwed onto the threaded body 140 such that the threaded nut 120 is positioned flush against a surface of the saddle head 110. The threaded body 140 extends through the collar 130 such that the threaded nut 120 is interposed between the saddle head 110 and the collar 130. The hammer head (not shown) includes a threaded opening in a first surface of the hammer head into which the threaded body 140 is screwed until the collar 130 interfaces with the first surface of the hammer head. The collar 130 is made of a plastic material, such as nylon-6,6 and include shock-absorbing features to reduce wearing down of other components of the bolt 100, such as the saddle head 110 and/or the threaded body 140.

Use of the conventional bolt 100 to fasten the hammer cap to the hammer head leads to various disadvantages. The geometry of the saddle head 110 is difficult to cast, resulting in high material costs relative to flatter geometries because of the increased surface area and volume of the saddle geometry relative to prism-shaped designs. The bolt 100 may not sufficiently contact the hammer cap and/or the hammer head such that repeated use of the hammer incorporating the bolt 100 causes the bolt 100 to strip out an interior of the hammer cap and/or the hammer head. Stripping out of the hammer cap and/or the hammer head eventually causes the bolt 100 to fail to contact the hammer cap and/or the hammer head and leads to the hammer cap disconnecting from the hammer head in such a way that the hammer cap and/or the hammer head must be replaced.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a hammer-cap fastener may include a fastener head. The fastener head may include one or more beveled edges along a lateral surface of the fastener head. The hammer-cap fastener may include a threaded body having a first end coupled to the fastener head. The hammer-cap fastener may include a ring circumscribing the first end of the threaded body such that the ring is positioned flush against the fastener head. The ring may include a first surface positioned flush against the fastener head and a second surface through which the threaded body extends, the first surface of the ring having a larger area than the second surface of the ring. The first surface and the second surface of the ring may be connected by a sloped lateral surface. The hammer-cap fastener may couple a hammer cap to a hammer head.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 is an example illustration of a bolt used to secure a hammer cap to a hammer head;

FIG. 2 is an example embodiment of a hammer-cap fastener according to the present disclosure;

FIG. 3 is a side view of the example embodiment of the hammer-cap fastener according to the present disclosure; and

FIG. 4 is a top-down view of the example embodiment of the hammer-cap fastener according to the present disclosure.

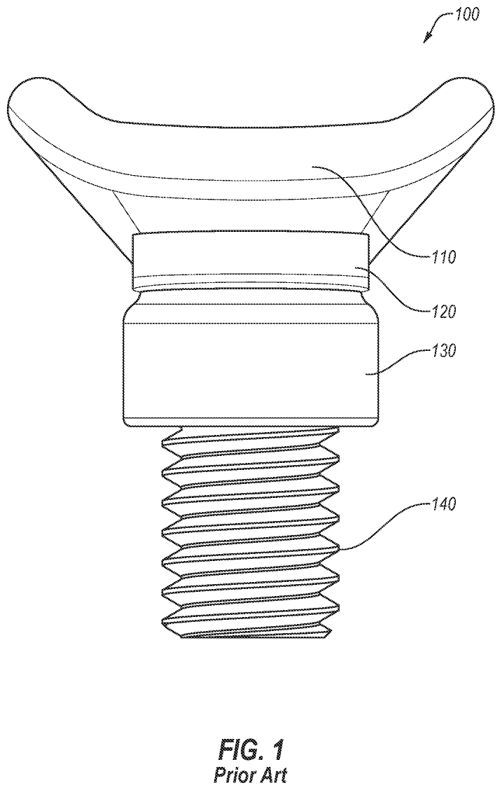

### DETAILED DESCRIPTION

A hammer cap may be coupled to a hammer head in various ways. A hammer cap may be included as a continuous part of the hammer head by including the hammer cap in a die cut of the hammer head when the hammer head is forged. The hammer cap included in the die cut of the hammer head may be unremovable from the hammer head.

Different hammer caps may be more suitable for different applications. For example, a claw hammer including a first hammer cap at a first end of the claw hammer having a circular cross-section and a second hammer cap at a second end of the claw hammer having a tapered profile split in the middle of the second hammer cap may be effective in carpentry applications where the hammer is used to install and/or remove nails. As another example, a mallet including one or more hammer caps having larger surface areas and/or softer materials such as rubber or wood may be effective for various purposes, such as machining and/or food processing.

A user may use different hammers for different purpose. However, it may be undesirable for the user to own and/or carry a hammer for each occasion. As such, a hammer may include interchangeable hammer caps attachable to one or both ends of an interchanging hammer head. Each of the interchangeable hammer caps may include a first end capable of interfacing with the interchanging hammer head and a second striking end. For example, a given interchanging hammer head may include a hexagonal socket, and a given interchangeable hammer cap may include a first hexagonal end capable of interfacing with the hexagonal socket of the given interchanging hammer head. A second end of the given interchangeable hammer cap may include a large circular cross-section such that the given interchanging hammer including the given interchangeable hammer cap may function as a mallet.

The present disclosure relates to, among other things, a hammer-cap fastener capable of securing the hammer cap to the hammer head. The hammer-cap fastener may include a fastener head, which may be fixed to the hammer cap. In some embodiments, the fastener head may include one or more beveled edges. A ring positioned below the fastener head may be interposed between the fastener head and a threaded body of the hammer-cap fastener.

The hammer-cap fastener according to the present disclosure may present one or more advantages over other fasteners used to secure the hammer cap to the hammer head. The hammer-cap fastener may include a cross-sectional geometry that may be manufactured using less material such that the hammer-cap fastener is cheaper to produce. Additionally or alternatively, the hammer-cap fastener may not strip out as quickly and/or as frequently as other fasteners.

Embodiments of the present disclosure are explained with reference to the accompanying figures.

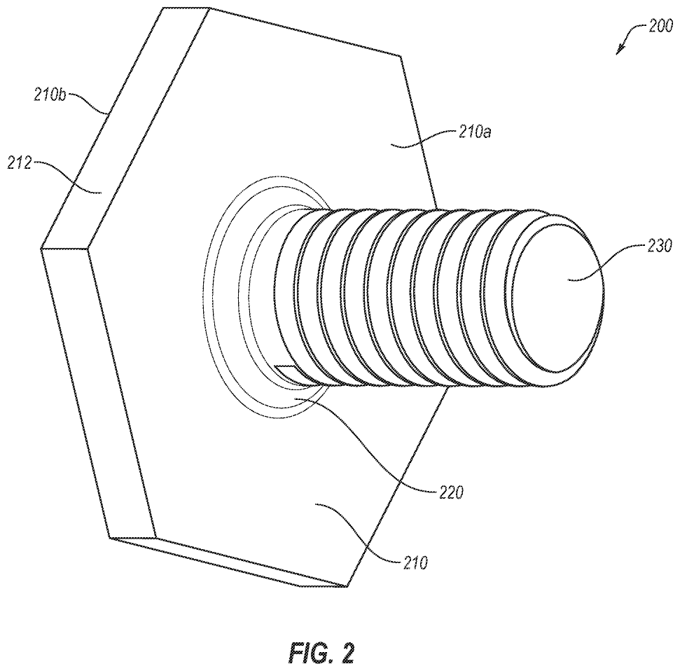

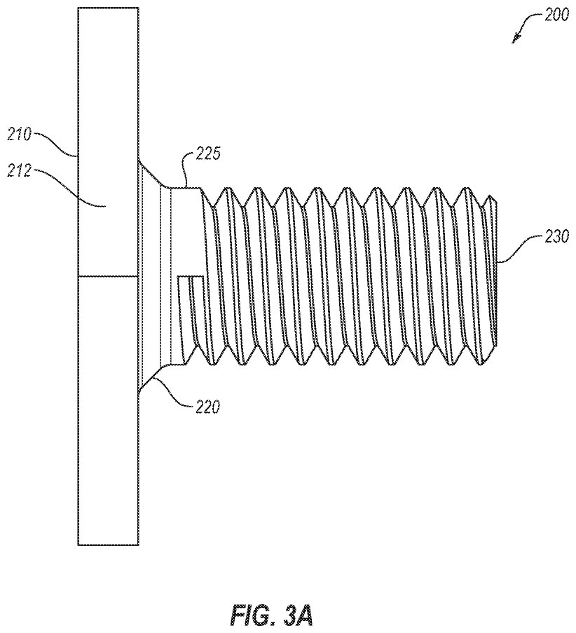

FIG. 2 illustrates an example embodiment of a hammer-cap fastener 200 according to the present disclosure. The hammer-cap fastener 200 may include a fastener head 210, a ring 220, and a threaded body 230. In some embodiments, the fastener head 210 may include a flat or substantially flat bottom surface 210a with which the ring 220 interfaces. The fastener head 210 may include one or more edges 212 and a flat or substantially flat top surface 210b in which the top surface 210b is a surface opposite to the bottom surface 210a. The threaded body 230 may extend from the ring 220. The fastener head 210 may be coupled to and/or embedded in the hammer cap, and the threaded body 340 may extend into the hammer head such as through a threaded opening in the hammer head. In these and other embodiments, the hammer-cap fastener 200 may be made of a material capable of withstanding impacts associated with use of the hammer, such as tempered steel, hardened steel, chromium alloy, cast iron, titanium, etc., to prevent stripping out of the hammer-cap fastener 200, the hammer cap, and/or the hammer head after repeated usage of the hammer. In some embodiments, one or more of the edges 212 may include a beveled profile. The beveled profile of the edges 212 may increase a contact surface area between the fastener head 210 and the hammer cap to improve gripping of the hammer cap by the fastener head 210 relative to the saddle head 110 of the conventional bolt 100.

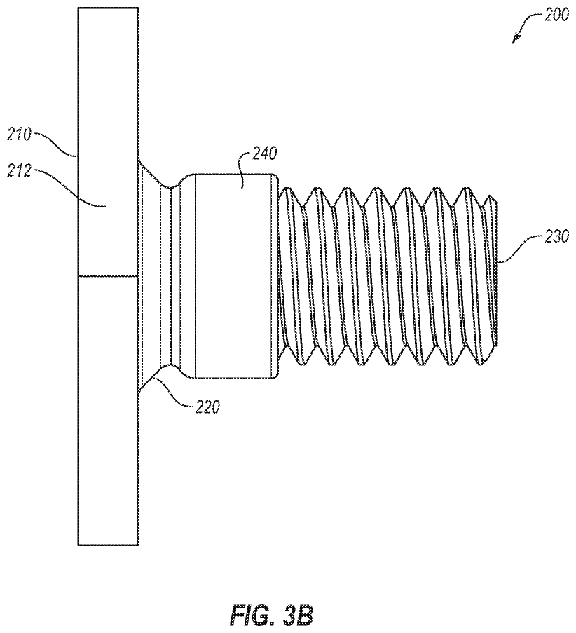

FIG. 3 illustrates a side view of the example embodiment of the hammer-cap fastener 200 according to the present disclosure. In some embodiments, the ring 220 may include a tapered profile in which a wider first surface is positioned flush against the fastener head 210 and a smaller second surface is positioned flush against the threaded body 230. In these and other embodiments, a collar (not shown), such as the collar 130, may be placed flush against the ring 220 and the bottom surface 210a of the fastener head 210. The tapered profile of the ring 220 may facilitate installation of the collar and improve positioning of the collar relative to installation and/or positioning of the collar 130 of the conventional bolt 100. The collar may be made of nylon-6,6, nylon-12, epoxy resin, black urethane, or some other plastic material. The tapering of the ring 220 may increase a contact surface between the ring 220 and the collar and/or reduce space gaps between the bottom surface 210a of the fastener head 210 and a top surface of the hammer head. Additionally or alternatively, the tapering of the ring 220 may control positioning of the collar along the length of the threaded body 230 such that a number of threaded contacts of the threaded body 230 protruding from below the collar may be adjusted. In some embodiments, the ring 220 may extend into a shoulder section 225 of the hammer-cap fastener 200. The shoulder section 225 may improve placement of the collar against the ring 220 by providing a surface smoother than the threaded body 230 against which the collar may be positioned.

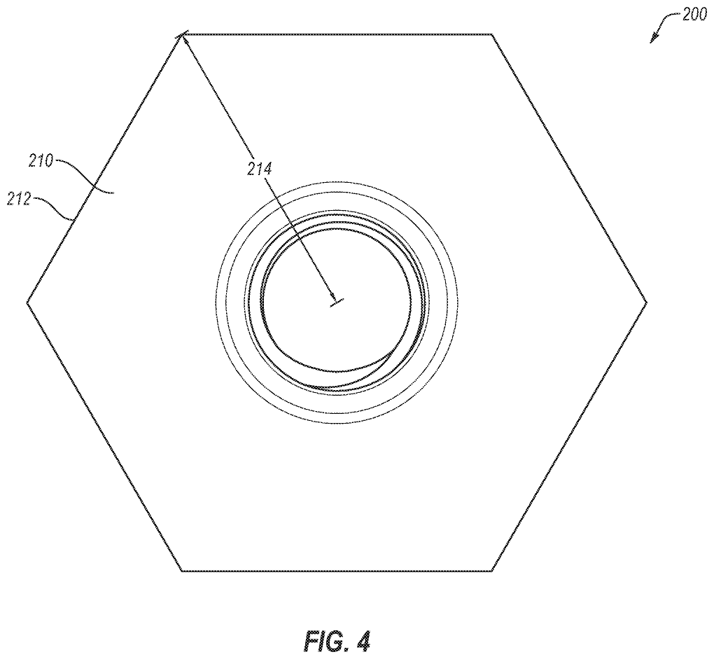

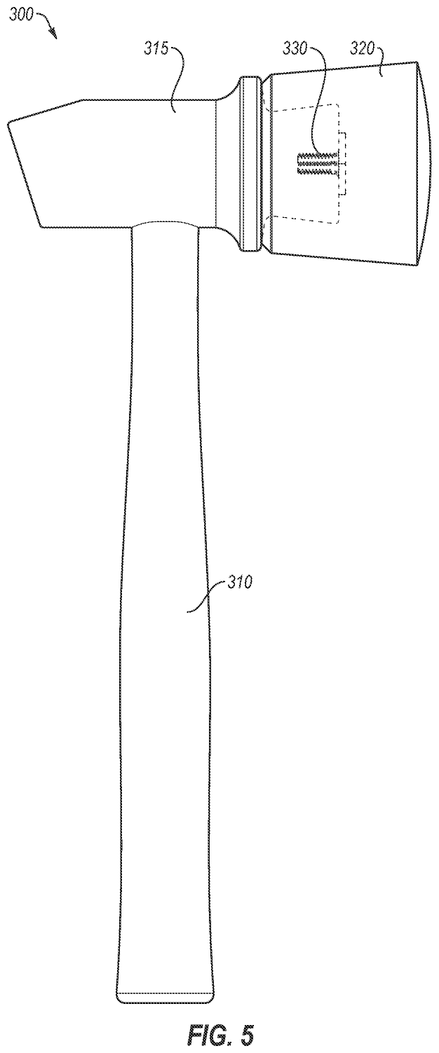

FIG. 4 illustrates a top-down view of the example embodiment of the hammer-cap fastener 200 according to the present disclosure. The top-down view of the hammer-cap fastener 200 may illustrate a cross-sectional geometry of the fastener head 210 and a radius 214 of the fastener head 210. The cross-sectional geometry and/or the radius 214 of the fastener head 210 may facilitate gripping of the hammer cap and/or the hammer head. In some embodiments, the fastener head 210 may include a hexagonal shape including six edges. Additionally or alternatively, the fastener head 210 may include a square, pentagonal, octagonal, etc. cross-sectional geometry. Side surfaces of the fastener head 210 may increase an area of contact between the hammer-cap fastener 200 and the interior of the hammer cap, which may reduce movement of the hammer-cap fastener 200 relative to fastener heads having shorter radii. Additionally or alternatively, manufacturing the fastener head 210 may require less material than the saddle head 110 of the conventional bolt 100 such that the fastener head 210 is less expensive to manufacture than the saddle head 110 of the conventional bolt 100. In some embodiments, specifications of the hammer-cap fastener 200 including the geometry, radius, thickness, etc. of the hammer-cap fastener 200 may be determined based on the type of hammer cap with which the hammer-cap fastener 200 interfaces.

In some embodiments, the hammer-cap fastener 200 may include a fastener head 210 having an apothem length (the length from a midpoint of an edge of the fastener head 210 to a center of the fastener head 210) ranging from 0.40 inches to 0.60 inches. In these and other embodiments, the fastener head 210 may include a thickness ranging from 0.10 inches to 0.15 inches. In these and other embodiments, the first surface of the ring 220 may include a thickness ranging from 0.04 inches to 0.07 inches. In these and other embodiments, the threaded body 230 of the hammer-cap fastener 200 may include a length ranging from 0.5 inches to 0.8 inches such that a length of the entire hammer-cap fastener 200 may range from approximately 0.60 inches to 1.10 inches.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

1. A hammer-cap fastener, comprising:
a fastener head;
a threaded body having a first end coupled to the fastener head; and
a ring circumscribing the first end of the threaded body such that the ring is positioned flush against the fastener head, wherein the ring extends from a bottom surface of the fastener head towards a lateral surface of the threaded body along a tapered lateral surface of the ring.

2. The hammer-cap fastener of claim 1, further comprising a collar circumscribing the threaded body positioned flush against the ring such that the ring is interposed between the fastener head and the collar.

3. The hammer-cap fastener of claim 2, wherein the collar is made of at least one material selected from a group comprising nylon-6,6, nylon-12, and epoxy resin.

4. The hammer-cap fastener of claim 1, wherein the fastener head includes a square, pentagonal, hexagonal, or octagonal cross-sectional geometry.

5. The hammer-cap fastener of claim 4, wherein the fastener head includes the hexagonal cross-sectional geometry.

6. The hammer-cap fastener of claim 1, wherein the fastener head includes one or more beveled edges along a lateral surface of the fastener head.

7. (canceled)

8. The hammer-cap fastener of claim 1, wherein the fastener head, the threaded body, and the ring are made of at least one material selected from a group comprising hardened steel, tempered steel, cast iron, chromium alloy, and titanium.

9. A hammer, comprising:
a handle;
a hammer head;
a hammer cap; and
a hammer-cap fastener coupling the hammer cap and the hammer head, the hammer-cap fastener comprising:
a fastener head;
a threaded body having a first end coupled to the fastener head; and
a ring circumscribing the first end of the threaded body such that the ring is positioned flush against the fastener head, wherein the ring extends from a bottom surface of the fastener head towards a lateral surface of the threaded body along a tapered lateral surface of the ring.

10. The hammer of claim 9, wherein the hammer-cap fastener further comprises a collar circumscribing the threaded body positioned flush against the ring such that the ring is interposed between the fastener head and the collar.

11. The hammer of claim 10, wherein the collar is made of at least one material selected from a group comprising nylon-6,6, nylon-12, and epoxy resin.

12. The hammer of claim 9, wherein the fastener head includes a square, pentagonal, hexagonal, or octagonal cross-sectional geometry.

13. The hammer of claim 12, wherein the fastener head includes the hexagonal cross-sectional geometry.

14. The hammer of claim 9, wherein the fastener head includes one or more beveled edges along a lateral surface of the fastener head.

15. (canceled)

16. The hammer of claim 9, wherein the fastener head, the threaded body, and the ring are made of at least one material selected from a group comprising hardened steel, tempered steel, cast iron, chromium alloy, and titanium.

17. The hammer of claim 9, wherein:
the hammer cap includes a central indentation in a first surface of the hammer cap;
the fastener head of the hammer-cap fastener is embedded in the central indentation of the hammer cap;
the hammer head includes a threaded opening in a first end of the hammer head; and
the threaded body of the hammer-cap fastener extends into the threaded opening in the first end of the hammer head such that the first end of the hammer head interfaces with the central indentation of the hammer cap.

18. A method of fastening a hammer cap to a hammer head, the method comprising:
coupling the hammer cap to a first end of a hammer-cap fastener; and
coupling the hammer head to a second end of the hammer-cap fastener, the hammer-cap fastener comprising:
a fastener head;
a threaded body having a first end coupled to the fastener head; and
a ring circumscribing the first end of the threaded body such that the ring is positioned flush against the fastener head, wherein the ring extends from a bottom surface of the fastener head towards a lateral surface of the threaded body along a tapered lateral surface of the ring.

19. The method of claim 18, wherein:
the hammer cap includes a central indentation in a first surface of the hammer cap;
the fastener head of the hammer-cap fastener is embedded in the central indentation of the hammer cap;
the hammer head includes a threaded opening in a first end of the hammer head; and
the threaded body of the hammer-cap fastener extends into the threaded opening in the first end of the hammer head such that the first end of the hammer head interfaces with the central indentation of the hammer cap.

20. (canceled)
